(19) United States
(12) Patent Application Publication
(10) Pub. No.: US 2014/0003490 A1
(43) Pub. Date: Jan. 2, 2014

(54) WIRELESS DISPLAY SOURCE DEVICE AND SINK DEVICE

(71) Applicant: Samsung Electronics Co., Ltd, Suwon-si (KR)

(72) Inventors: Jun-Young CHO, Suwon-si (KR); Jian GAO, Suwon-si (KR); Shin-Won LEE, Hwaseong-si (KR); Pyoung-Jae JUNG, Seoul (KR)

(73) Assignee: Samsung Electronics Co., Ltd.

(21) Appl. No.: 13/928,869

(22) Filed: Jun. 27, 2013

(30) Foreign Application Priority Data
Jun. 28, 2012 (KR) 10-2012-0070085

(51) Int. Cl. H04N 7/26

(52) U.S. Cl. CPC H04N 19/00018
USPC 375/240.02

(57) ABSTRACT

There is provided a wireless display source device comprising, an encoder which encodes a first multimedia signal according to a first scheme to generate a first encoded multimedia signal, and encodes a second multimedia signal different from the first multimedia signal according to a second scheme to generate a second encoded multimedia signal, a controller which sets an encoding scheme of the encoder such that the first scheme is different from the second scheme, and a wireless interface which transmits the encoded multimedia signal to a wireless display sink device.

### CROSS-REFERENCE TO RELATED APPLICATIONS

This application claims priority from Korean Patent Application No. 10-2012-0070085 filed on Jun. 28, 2012 in the Korean Intellectual Property Office, and all the benefits accruing therefrom under 35 U.S.C. 119, the contents of which in its entirety are herein incorporated by reference.

### BACKGROUND OF THE INVENTION

1. Field of the Invention

The present inventive concept relates to a wireless display source device and sink device.

2. Description of the Related Art

A wireless display system includes a source device which transmits multimedia contents, and a sink device which receives and reproduces the multimedia contents. Various wireless communication devices such as a personal computer, digital television, set top box, media projector, handheld device, and consumer electronics device may be applied to the source device and the sink device. Further, the source device and the sink device may be connected to each other through various wireless networks such as Wireless Fidelity (WiFi), Wireless Broadband Internet (WiBro), High Speed Downlink Packet Access (HSDPA), World Interoperability for Microwave Access (WIMAX), ZigBee, and Bluetooth.

### SUMMARY OF THE INVENTION

The present general inventive concept provides a wireless display source device which encodes and transmits multimedia contents according to various schemes during wireless display.

Additional features and utilities of the present general inventive concept will be set forth in part in the description which follows and, in part, will be obvious from the description, or may be learned by practice of the general inventive concept.

The present general inventive concept also provides a wireless display sink device which receives the multimedia contents encoded according to various schemes during wireless display.

The objects of the present general inventive concept are not limited thereto, and the other objects of the present general inventive concept will be described in or be apparent from the following description of the embodiments.

Exemplary embodiments of the present general inventive concept provide a wireless display source device comprising, an encoder which encodes a first multimedia signal according to a first scheme to generate a first encoded multimedia signal, and encodes a second multimedia signal different from the first multimedia signal according to a second scheme to generate a second encoded multimedia signal, a controller which sets an encoding scheme of the encoder such that the first scheme is different from the second scheme, and a wireless interface which transmits the encoded multimedia signal to a wireless display sink device.

Exemplary embodiments of the present general inventive concept also provide a wireless display source device comprising, an encoder which receives and encodes a multimedia signal to generate an encoded multimedia signal, a controller which changes an encoding scheme of the multimedia signal by setting encoding parameters of the encoder according to system utilization information, and a wireless interface which transmits the encoded multimedia signal to a wireless display sink device.

According to the wireless display source device and sink device in accordance with the embodiments of the present general inventive concept, since the wireless display source device encodes and transmits the multimedia contents according to various schemes, and the wireless display sink device receives the multimedia contents encoded according to various schemes, it is possible to achieve optimal quality and fast response time according to the characteristics of multimedia contents.

Exemplary embodiments of the present general inventive concept also provide a wireless display source device, comprising an encoder to receive and encode a multimedia signal, a controller to select an encoding scheme for the encoder from a plurality of stored encoding profiles, and a wireless interface which transmits the encoded multimedia signal to a wireless display sink device, wherein the plurality of stored encoding profiles vary in terms of audio and video encoding formats associated with respective profiles

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a schematic block diagram showing a configuration of a wireless display system in accordance with an embodiment of the present general inventive concept;

FIG. 2 is a schematic block diagram showing a configuration of a wireless display source device in accordance with the embodiment of the present general inventive concept;

FIG. 3 is a schematic block diagram showing a configuration of a wireless display sink device in accordance with the embodiment of the present general inventive concept;

FIG. 4 is a schematic block diagram showing a configuration in which a preset is selected to set a profile in the wireless display source device in accordance with the embodiment of the present general inventive concept;

FIG. 5 is a schematic flowchart showing an operation of the wireless display source device of FIG. 4 during the wireless display;

FIGS. 6 to 8 are schematic diagrams showing the streams which are transmitted from the wireless display source device in accordance with the embodiment of the present general inventive concept;

FIG. 9 is a schematic block diagram showing a configuration in which a target profile is calculated to set a profile in the wireless display source device in accordance with another embodiment of the present general inventive concept;

FIG. 10 is a schematic flowchart showing an operation of the wireless display source device of FIG. 9 during the wireless display;

FIG. 11 is a schematic block diagram showing a configuration in which a profile is set according to user setting in the wireless display source device in accordance with another embodiment of the present general inventive concept; and

FIG. 12 is a schematic flowchart showing an operation of the wireless display source device of FIG. 11 during the wireless display.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

It will also be understood that when a layer is referred to as being “on” another layer or substrate, it can be directly on the other layer or substrate, or intervening layers may also be present. In contrast, when an element is referred to as being “directly on” another element, there are no intervening elements present.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The use of the terms “a” and “an” and “the” and similar referents in the context of describing the general inventive concept (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

Unless defined otherwise, all technical and scientific terms used herein have the same meaning as commonly understood by one of ordinary skill in the art to which this general inventive concept belongs. It is noted that the use of any and all examples, or exemplary terms provided herein is intended merely to better illuminate the general inventive concept and is not a limitation on the scope of the general inventive concept unless otherwise specified. Further, unless defined otherwise, all terms defined in generally used dictionaries may not be overly interpreted.

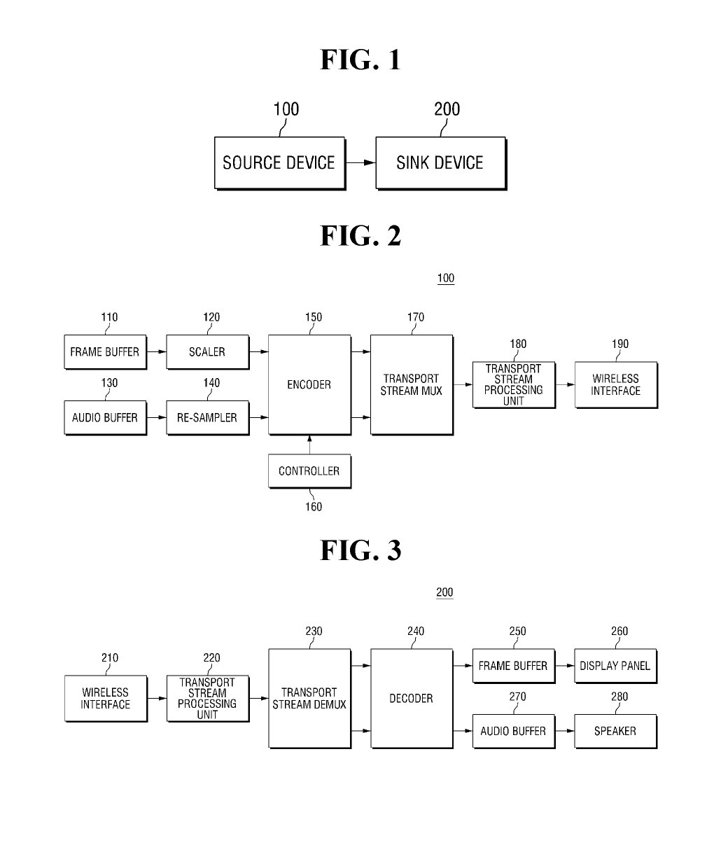

Referring to FIG. 1, a wireless display system in accordance with an embodiment of the present general inventive concept includes a source device 100 and a sink device 200.

The source device 100 is a wireless communication device to transmit multimedia contents, and the sink device 200 is a wireless communication device to receive and reproduce the multimedia contents.

The multimedia contents include multimedia signals of audio data, video data or the like of an application being executed in the source device 100. Further, the application being executed in the source device 100 may be one stored in the source device 100 or transmitted from an external device.

The multimedia contents may have various characteristics according to the type of the application being executed in the source device 100. For example, the multimedia contents may be required to have a high quality or fast response time according to the type of the application. Conversely, the multimedia contents may be allowed to have a poor quality or slow response time according to the type of the application.

To this end, the source device 100 may encode a first multimedia signal according to a first scheme and transmit a first encoded multimedia signal to the sink device 200, or encode a second multimedia signal according to a second scheme and transmit a second encoded multimedia signal to the sink device 200.

Accordingly, the sink device 200 may receive the first encoded multimedia signal from the source device 100, and reproduce the first multimedia signal obtained by decoding the first encoded multimedia signal according to the first scheme, or receive the second encoded multimedia signal from the source device 100, and reproduce the second multimedia signal obtained by decoding the second encoded multimedia signal according to the second scheme.

Various wireless communication devices, including but not limited to, a personal computer, digital television, set top box, media projector, handheld device, and consumer electronics device may be applied to the source device 100 and the sink device 200.

Although FIG. 1 illustrates a scenario in which the source device 100 and the sink device 200 are connected to each other through a Wi-Fi wireless network, the number and form of source devices and sink devices connected to each other are not limited thereto.

FIG. 2 is a schematic block diagram showing a configuration of a wireless display source device in accordance with the embodiment of the present general inventive concept.

Referring to FIG. 2, the wireless display source device 100 in accordance with the embodiment of the present general inventive concept includes: a frame buffer 110, a scaler 120, an audio buffer 130, a re-sampler 140, an encoder 150, a controller 160, a transport stream mux 170, a transport stream processing unit 180, and a wireless interface 190.

The frame buffer 110 temporarily stores video data displayed on the display screen of the source device 100. Each storage unit of the frame buffer 110 stores video data corresponding to each pixel unit of the display screen of the source device 100. In this case, the video data stored in the frame buffer 110 is obtained by capturing video signals of the application being executed in the source device 100.

Further, the video data stored in the frame buffer 110 may be selectively displayed or may not be selectively displayed on the display screen of the source device 100. That is, although the video data of the application being executed in the source device 100 is not displayed on the display screen of the source device 100 during the wireless display, it may be transmitted to the sink device 200 and displayed on the display screen of the sink device 200. Accordingly, the source device 100 need not include a local display panel.

The scaler 120 receives the video data of the source device 100 from the frame buffer 110. The scaler 120 may convert the resolution of the received video data according to the target resolution.

The audio buffer 130 temporarily stores the audio data outputted to a speaker of the source device 100. In this case, the audio data stored in the audio buffer 130 is obtained by capturing audio signals of the application being executed in the source device 100.

Further, the audio data stored in the audio buffer 130 may be selectively outputted or may not be outputted to the speaker of the source device 100. That is, although the audio data of the application being executed in the source device 100 is not outputted to the speaker of the source device 100 during the wireless display, it may be transmitted to the sink device 200 and outputted to the speaker of the sink device 200. Accordingly, the source device 100 may not include a local speaker.

The re-sampler 140 receives the audio data of the source device 100 from the audio buffer 130. The re-sampler 140 may perform re-sampling by filtering the received audio data.

The encoder 150 receives the video data from the scaler 120 and receives the audio data from the re-sampler 140. The encoder 150 encodes the received video data and audio data respectively according to various schemes to generate encoded (or compressed) video data and encoded (or compressed) audio data.

The controller 160 sets the encoding scheme of the encoder 150 such that the first scheme to encode the first multimedia signal is different from the second scheme to encode the second multimedia signal. The controller 160 sets a profile of the encoder 150, and allows the video data and the audio data to be encoded respectively by various schemes according to the set profile. In this case, the profile represents a set of parameters defined to determine the encoding scheme of the encoder 150.

The transport stream mux 170 receives the encoded video data and the encoded audio data from the encoder 150. The transport stream mux 170 generates a transport stream packet by multiplexing the encoded video data and the encoded audio data, for example, according to a Moving Picture Exports Group-2 Transport Stream (MPEG2-TS) scheme, and packetizing them into the audio/video stream in order to simultaneously transmit both the encoded video data and the encoded audio data. Various flags and program identification (PID) to specify the program information may be inserted into a header of the transport stream packet.

The transport stream processing unit 180 receives the transport stream packet from the transport stream mux 170. The transport stream processing unit 180 inserts the transport stream packet into a payload of the Real-time Transport Protocol (RTP) to be capsulized into an RTP packet. The encoding format of the audio/video stream may be inserted into the header of the RTP packet as a type of payload.

Further, the transport stream processing unit 180 inserts the RTP packet into the payload of the User Datagram Protocol (UDP) packet to be capsulized into the UDP packet. The transport stream processing unit 180 may insert source and destination ports and the like of the audio/video stream into the header of the UDP packet.

Further, the transport stream processing unit 180 may insert the UDP packet into the payload of the Internet Protocol (IP) packet to be capsulized into the IP packet.

The wireless interface 190 is connected to the sink device 200, for example, through a Wi-Fi wireless network under connection conditions such as a predetermined frequency and connection method. Then, the source device 100 transmits the audio/video stream capsulized into the IP packet to the sink device 200 through the wireless interface 190.

FIG. 3 is a schematic block diagram showing a configuration of a wireless display sink device in accordance with the embodiment of the present general inventive concept.

Referring to FIG. 3, the wireless display sink device 200 in accordance with an embodiment of the present general inventive concept includes a wireless interface 210, a transport stream processing unit 220, a transport stream demux 230, a decoder 240, a frame buffer 250, a display panel 260, an audio buffer 270, and a speaker 280.

The wireless interface 210 is connected to the source device 100 through, for example, a Wi-Fi wireless network under the connection conditions such as a predetermined frequency and connection method. Then, the sink device 200 receives the audio/video stream capsulized into the IP packet is received from the source device 100 through the wireless interface 210.

The transport stream processing unit 220 receives the IP packet from the wireless interface 210. The transport stream processing unit 220 extracts the UDP packet from the payload of the IP packet. Next, the transport stream processing unit 220 extracts the RTP packet from the payload of the UDP packet. Then, the transport stream processing unit 220 extracts the transport stream packet from the payload of the RTP packet.

The transport stream demux 230 receives the transport stream packet from the transport stream processing unit 220. The transport stream demux 230 demultiplexes the transport stream packet of the audio/video stream into the encoded video data and the encoded audio data according to, for example, the MPEG2-TS scheme. In this case, the transport stream demux 230 may extract the encoded video data and the encoded audio data from the transport stream packet by referring to the PID information.

The decoder 240 receives the encoded video data and the encoded audio data from the transport stream demux 230. The decoder 240 decodes (or decompresses) the encoded video data and the encoded audio data according to various schemes to generate the decoded video data and the decoded audio data.

The frame buffer 250 receives the decompressed video data from the decoder 240. Further, the received video data is transmitted to the display panel 260 from the frame buffer 250 and displayed on the display screen of the sink device 200.

The audio buffer 270 receives the decompressed audio data from the decoder 240. Then, the received audio data is transmitted from the audio buffer 270 to the speaker 280, and outputted from the speaker 280 of the sink device 200. In this case, the audio data may be converted into, for example, a Pulse Code Modulation (PCM) signal according to a predetermined audio codec before being transmitted to the speaker 280.

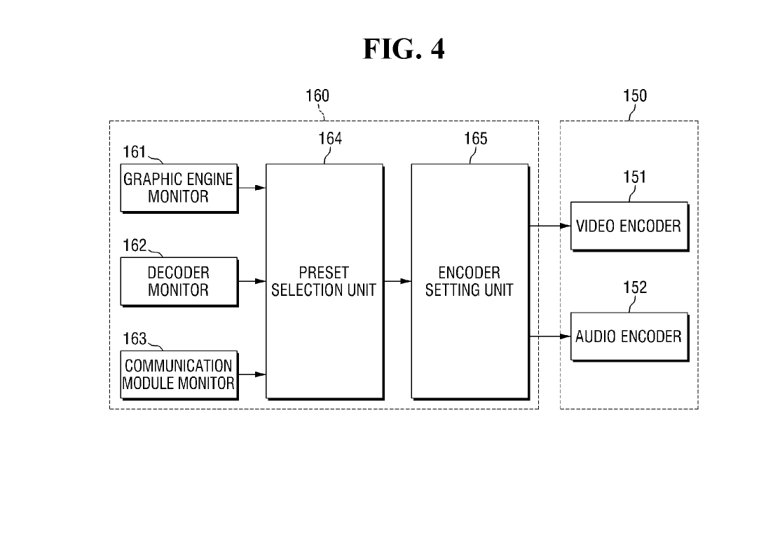

FIG. 4 is a schematic block diagram showing a configuration in which a preset is selected to set a profile in the wireless display source device in accordance with the embodiment of the present general inventive concept.

Referring to FIG. 4, the wireless display source device 100 in accordance with the embodiment of the present general inventive concept includes the controller 160 to set the profile according to the type of the application, and the encoder 150 to encode the video data and the audio data according to the set profile.

The controller 160 includes a graphic engine monitor 161, a decoder monitor 162, a communication module monitor 163, a preset selection unit 164, and an encoder setting unit 165.

The graphic engine monitor 161 monitors the utilization of the graphic engine of the source device 100. In this case, the graphic engine represents a hardware or software independently performing the processing of the graphic command. Further, the graphic engine may include a three-dimensional graphic engine to process the video data in three-dimensional spatial coordinates of x-axis, y-axis and z-axis, a two-dimensional graphic engine to process the video data in two-dimensional spatial coordinates of x-axis and y-axis, or the like.

The graphic engine monitor 161 may monitor and analyze the state information such as 3D graphic engine utilization, frame update rate and 2D graphic engine utilization as the system utilization information of the application. Further, the graphic engine monitor 161 may monitor the engine utilization in the form of a ratio for each Vertical Synchronizing Signal (VSYNC).

The decoder monitor 162 monitors the utilization of the decoder of the source device 100. In this case, the decoder decodes the video data to be displayed on the display screen of the source device 100. The video data temporarily stored in the frame buffer 110 is decompressed video data that has been decoded in the decoder.

The decoder monitor 162 may monitor and analyze the state information such as the decoder engine utilization, the frame update rate of the contents to be reproduced after being decoded by the decoder, the resolution of the contents to be reproduced after being decoded by the decoder as the system utilization information of the application.

The communication module monitor 163 monitors the utilization of the communication module of the source device 100. In this case, the communication module represents a hardware or software module that achieves a call between a caller and a receiver by using a wireless communication line or the wireless interface 190 of the source device 100. The communication module may perform, e.g., a voice call, video call, or data call. The data call represents, for example, Voice over Internet Protocol (VoIP), Mobile Voice over Internet Protocol (mVoIP) or the like, in which a call is made based on the internet protocol Voice over Internet Protocol.

The communication module monitor 163 may monitor and analyze the state information on whether the state of the communication module is a voice call state, video call state, or a data call state, as the system utilization information of the application.

The preset selection unit 164 receives the system utilization information of the application from the graphic engine monitor 161, the decoder monitor 162 and the communication module monitor 163. The preset selection unit 164 determines the type of the application based on the state information of the communication module, the decoder and the graphic engine used by the application. Then, the preset selection unit 164 selects a preset determined in advance according to the type of the determined application.

Each preset includes an optimal profile set in advance corresponding to the type of each application, and the profile may include, e.g., audio response time, audio quality, video response time, video quality or the like.

Hereinafter, a case of selecting a preset based on the state information of the communication module, the decoder and the graphic engine will be described as an example with reference to Tables 1 and 2.

TABLE 1

Graphic Engine
State Information

| | | | |
|---|---|---|---|
| Preset | Low | Medium | High |

| | | | | |
|---|---|---|---|---|
| Decoder State | Low | Default | Photo | Game |
| Information | Medium | Movie | Default | Game |
| | High | Movie | Movie | Game |

TABLE 2

| | | Communication Module | | |
|---|---|---|---|---|
| | | State Information | | |
| Preset | | Voice | Video | Data |
| Decoder State | Low | Voice Call | Video Call | Voice Call |
| Information | Medium | Voice Call | Video Call | Video Call |
| | High | Voice Call | Video Call | Video Call |

Referring to Tables 1 and 2, the graphic engine state information and the decoder state information may be classified into a plurality of levels of low, medium, and high, and the communication module state information may be classified into call types of voice, video, data and the like. Types of the application may be classified into, e.g., default, photo, game, movie, voice call, video call and the like. The preset may be determined in advance corresponding to the type of the application.

First, referring to Table 1, if the graphic engine state information is of a high level, the preset selection unit 164 may estimate the type of the application as a game. Then, the game preset may store a profile corresponding to the game, for example, such that the video quality is low enough to ignore while the video response time is very short, and the audio quality is low enough to ignore while the audio response time is very short.

In another example, if the graphic engine state information is of a low level and the decoder state information is of a medium level, the preset selection unit 164 may estimate the type of the application as a movie. Then, the movie preset may store a profile corresponding to the movie, for example, such that the video quality is maximized while the video response time is very long, and the audio quality is maximized while the audio response time is long. Further, based on the decoder state information, the video response time and the video quality may be changed in conjunction with the utilization of the decoder and the resolution. The same is true for a case where the graphic engine state information is of a low or medium level, and the decoder state information is of a high level.

If the graphic engine state information is of a medium level and the decoder state information is of a high level, the preset selection unit 164 may estimate the type of the application as a photo. Then, the photo preset may store a profile corresponding to the photo, for example, such that the video quality is maximized while the video response time is long enough to ignore, and the audio quality is low while the audio response time is long.

If both the graphic engine state information and the decoder state information are of a low level, the preset selection unit 164 may estimate the type of the application as default. Here, default may mean an initial state where the type of the application is not specifically determined. Then, the default preset may store a profile corresponding to the default, for example, such that the video response time and the video quality are normal, and the audio response time and the audio quality are normal. The same is true for a case where both the graphic engine state information and the decoder state information are of a medium level.

Referring to Table 2, if the communication module state information is of a video type, the preset selection unit 164 may estimate the type of the application as a video call. Then, the video call preset may store a profile corresponding to the video call, for example, such that the video quality is normal while the video response time is short, and the audio quality is maximized while the audio response time is very short. The same is true for a case where the communication module state information is of a data type, and the decoder state information is of a medium or high level.

If the communication module state information is of a voice type, the preset selection unit 164 may estimate the type of the application as a voice call. Then, the voice call preset may store a profile corresponding to the voice call, for example, such that the video quality is maximized while the video response time is very long, and the audio quality is maximized while the audio response time is very short. The same is true for a case where the communication module state information is of a data type, and the decoder state information is of a low level.

Further, each preset may include an audio codec set in advance corresponding to the type of each application. For example, if the type of the application is a game, movie, photo or default, each preset may store a lossy compression codec, and if the type of the application is a voice call or video call, each preset may store a lossless compression codec.

The encoder setting unit 165 may set a profile of the encoder 150 according to the preset selected by the preset selection unit 164. Here, as described above, the profile may include audio response time, audio quality, video response time, video quality or the like.

Further, the encoder setting unit 165 may set an audio codec of the encoder 150 according to the preset selected by the preset selection unit 164.

The encoder 150 includes a video encoder 151 which encodes and compresses the video data, and an audio encoder 152 which encodes and compresses the audio data.

The video encoder 151 encodes the video data according to, e.g., an H.264 codec. The video encoder 151 provides the video data compressed at a resolution, bit rate and frame rate varied according to the set profile.

The audio encoder 152 encodes the audio data according to the codec such as, for example, LPCM, AAC, E-AC3 and DTS. If the audio codec is set, the audio encoder 152 performs lossless compression or lossy compression according to the set audio codec. The audio encoder 152 may provide the audio data compressed at a bit rate, sampling rate and channel varied according to the set profile.

Hereinafter, there will be described an operation of the wireless display source device 100 during the wireless display according to a configuration in which a preset is selected to set a profile in the wireless display source device 100 having the controller 160 of FIG. 4.

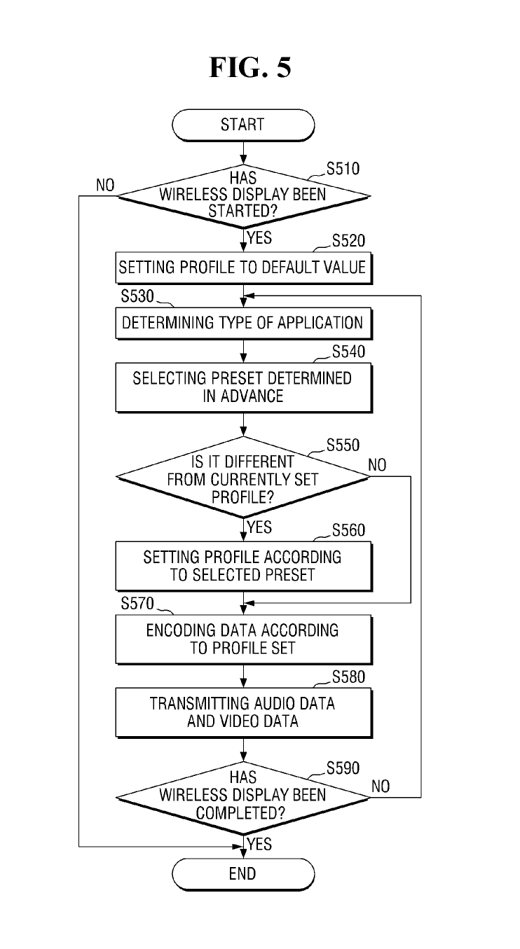

FIG. 5 is a schematic flowchart showing an operation of the wireless display source device 100 having the controller 160 of FIG. 4, during the wireless display.

Referring to FIG. 5, first, the controller 160 determines whether the wireless display has been started (S510). Then, if the wireless display has been started, the controller 160 sets the profile of the encoder 150 to a default value (S520). In this case, the default value represents an initial value to which the profile is set initially along with the start of the wireless display. The default value is the same value as the profile corresponding to the default preset.

Next, the controller 160 determines the type of application being executed in the source device 100 based on the state information of the communication module, the decoder and the graphic engine used by the application (S530). The controller 160 then selects the preset determined in advance according to the type of the determined application (S540).

Next, the controller 160 determines whether the currently set profile of the encoder 150 is different from the profile stored in the preset determined in advance (S550). If the currently set profile of the encoder 150 is different from the profile stored in the preset determined in advance, the controller 160 sets the profile of the encoder 150 according to the selected preset (S560). If the currently set profile of the encoder 150 is the same as the profile stored in the preset determined in advance, setting the profile according to the selected preset is omitted.

In the next step, the encoder 150 encodes the video data and the audio data according to the profile set by the controller 160 (S570). The encoded video data and the encoded audio data are multiplexed in the transport stream mux 170 according to, for example, the MPEG2-TS scheme, and packetized into the audio/video stream. Then, the transport stream packet packetized into the audio/video stream is finally capsulized into an IP packet in the transport stream processing unit 180.

Next, the wireless interface 190 transmits the audio data and the video data capsulized into the IP packet to the sink device 200 (S580). Finally, the controller 160 determines whether the wireless display has been completed (S590). If the wireless display has not been completed, the controller 160 repeats the above-described steps from S530.

Hereinafter, there will be described a case where a frame update frequency and a compression ratio of the audio data and the video data are determined according to the set profile in the wireless display source device 100 having the controller 160 of FIG. 4 in accordance with the embodiment of the present general inventive concept.

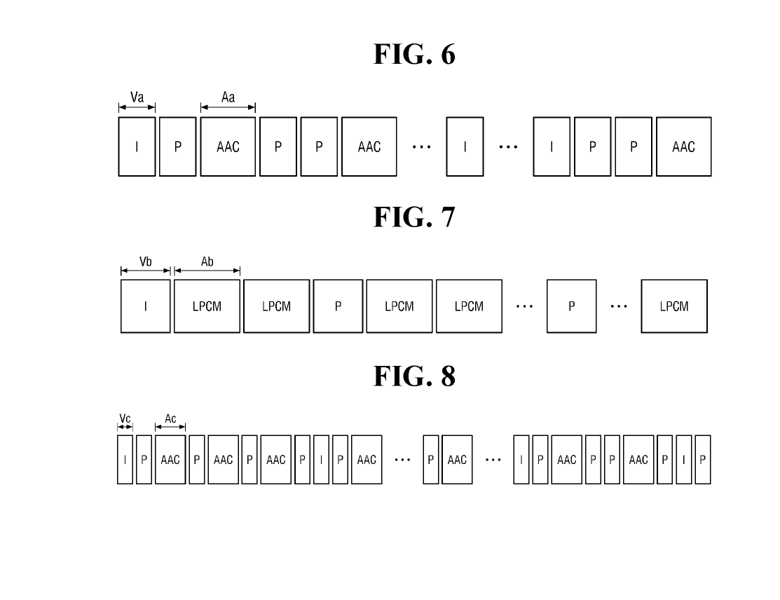

FIGS. 6 to 8 are schematic diagrams showing the streams which are transmitted from the wireless display source device 100 in accordance with an embodiment of the present general inventive concept. Here, I frames and P frames represent video frames encoded according to the H.264 codec. An I frame is a video frame which has been encoded independently without referring to any other frame, and a P frame is a video frame which has been encoded according to a difference after referring to the past I frame or the next P frame. Further, an AAC frame and an LPCM frame represent audio frames which have been encoded according to their codecs, respectively.

Referring to FIG. 6, an encoding profile is set according to the default preset, and the audio/video stream to be transmitted is illustrated. In case of the default preset, the video data and the audio data are encoded at a normal frame update frequency such that the video response time and the audio response time are normal. Further, the video data and the audio data are encoded at a normal compression ratio such that the video quality and the audio quality are normal. The encoded video data frame is generated to have a normal size Va and the encoded audio data frame is generated to have a normal size Aa.

Referring to FIG. 7, an encoding profile is set according to the voice call preset, and the audio/video stream to be transmitted is illustrated. In case of the voice call preset, the video data is encoded at a low video frame update frequency, and the audio data is encoded at a high audio frame update frequency such that the video response time is very long and the audio response time is very short. Further, the video data and the audio data are encoded at a low compression ratio such that the video quality and the audio quality are maximized. The encoded video data frame is generated to have a maximum size Vb and the encoded audio data frame is generated to have a maximum size Ab. In this case, the audio data may be encoded by LPCM, that is, a lossless compression codec.

Referring to FIG. 8, an encoding profile is set according to the game preset, and the audio/video stream to be transmitted is illustrated. In case of the game preset, the video data and the audio data are encoded at a high frame update frequency such that the video response time and the audio response time are very short. Further, the video data and the audio data are encoded at a high compression ratio such that the video quality and the audio quality are low enough to ignore. The encoded video data frame is generated to have a small size Vc and the encoded audio data frame is generated to have a small size Ac.

In the embodiment of the present general inventive concept, in order to adjust the response time, a case of adjusting the frame update frequency has been described, but the present general inventive concept is not limited thereto. That is, various methods such as transmitting the video data and the audio data without compression, and adjusting the encoding time such that the response time and quality are inversely proportional to each other may be applied.

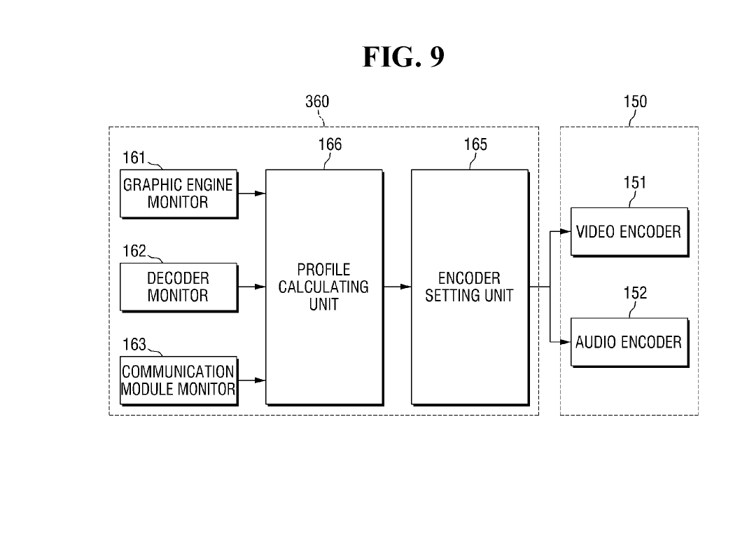

FIG. 9 is a schematic block diagram showing a configuration in which a target profile is calculated to set a profile in the wireless display source device 100 in accordance with another embodiment of the present general inventive concept.

Referring to FIG. 9, the wireless display source device 100 in accordance with another embodiment of the present general inventive concept includes the controller 360 which sets a profile based on the system utilization information, and the encoder 150 which encodes the video data and the audio data according to the set profile.

The controller 360 includes a graphic engine monitor 161, a decoder monitor 162, a communication module monitor 163, a profile calculating unit 166, and an encoder setting unit 165.

Since the graphic engine monitor 161, the decoder monitor 162, and the communication module monitor 163 are the same as the components described with reference to FIG. 4, a detailed description thereof will be omitted.

The profile calculating unit 166 receives the system utilization information of the application from the graphic engine monitor 161, the decoder monitor 162 and the communication module monitor 163. The profile calculating unit 166 calculates a target profile based on the state information of the communication module, the decoder and the graphic engine used by the application. The target profile may include, e.g., target response time, target quality or the like. Specifically, the target profile may include audio response time, audio quality, video response time, video quality or the like.

The profile calculating unit 166 calculates the profile to allow the wireless display system to exert optimal performance according to an optimization function as represented by

Eq. 1:

(Vr, Vq, Ar, Aq)=f(Ug, Ud, Uc) Eq. 1

where Vr represents the video response time, Vq represents the video quality, Ar represents the audio response time, Aq represents the audio quality, Ug represents the graphic engine state information, Ud represents the decoder state information, and Uc represents the communication module state information.

The encoder setting unit 165 sets the profile of the encoder 150 according to the profile calculated by the profile calculating unit 166. Here, as described above, the profile may include audio response time, audio quality, video response time, video quality or the like.

The encoder 150 includes the video encoder 151 which encodes and compresses the video data, and the audio encoder 152 which encodes and compresses the audio data.

Since the video encoder 151 and the audio encoder 152 are the same as the components described with reference to FIG. 4, a detailed description thereof will be omitted.

Hereinafter, there will be described an operation of the wireless display source device 100 during the wireless display according to a configuration in which a profile is calculated to set a profile in the wireless display source device 100 having the controller 360 of FIG. 9.

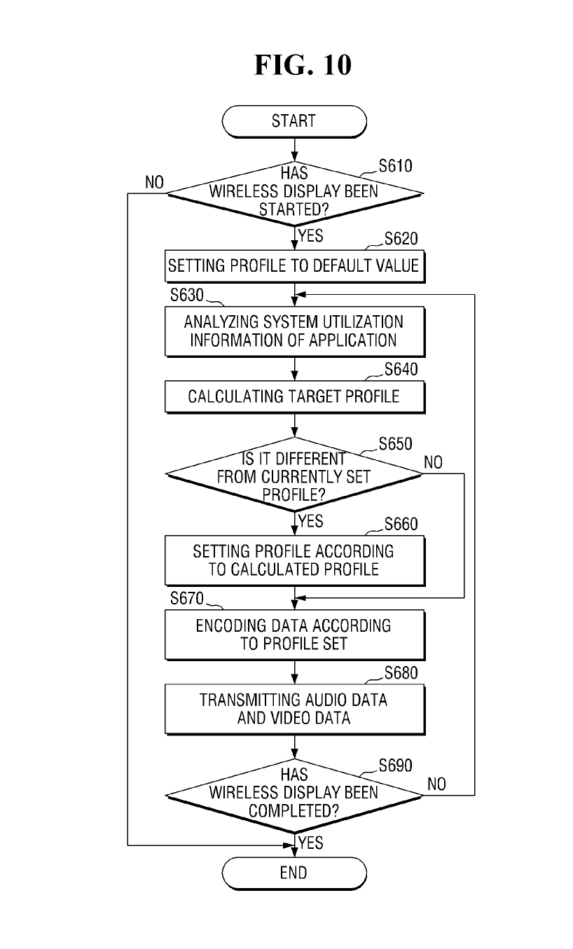

FIG. 10 is a schematic flowchart showing an operation of the wireless display source device 100 having the controller 360 of FIG. 9 during the wireless display.

Referring to FIG. 10, first, the controller 360 determines whether the wireless display has been started (S610). Then, if the wireless display has been started, the controller 360 sets the profile of the encoder 150 to a default value (S620). Here, the default value represents an initial value to which the profile is set initially along with the start of the wireless display.

Next, the controller 360 analyzes the system utilization information of the application (S630). The controller 360 calculates a target profile based on the results obtained by analyzing the state information of the communication module, the decoder 240 and the graphic engine used by the application (S640).

In the next step, the controller 360 determines whether the currently set profile of the encoder 150 is different from the calculated target profile (S650). If the currently set profile of the encoder 150 is different from the calculated target profile, the controller 360 sets the profile of the encoder 150 according to the calculated target profile (S660). If the currently set profile of the encoder 150 is the same as the calculated target profile, setting the profile according to the calculated target profile is omitted.

Next, the encoder 150 encodes the video data and the audio data according to the profile set by the controller 360 (S670). The encoded video data and the encoded audio data are multiplexed in the transport stream mux 170 according to, for example, the MPEG2-TS scheme, and packetized into the audio/video stream. Then, the transport stream packet packetized into the audio/video stream is finally capsulized into an IP packet in the transport stream processing unit 180.

Then, the wireless interface 190 transmits the audio data and the video data capsulized into the IP packet to the sink device 200 (S680). Finally, the controller 360 determines whether the wireless display has been completed (S690). If the wireless display has not been completed, the controller 360 repeats the above-described steps from S630.

In the wireless display source device 100 having the controller 360 of FIG. 9, since determining the frame update frequency and the compression ratio of the audio data and the video data according to the set profile is the same as that described above, a detailed description thereof will be omitted.

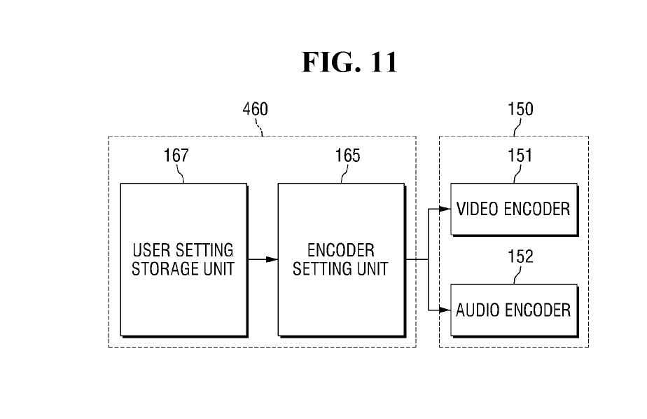

FIG. 11 is a schematic block diagram showing a configuration in which a profile is set according to a user setting in the wireless display source device 100 in accordance with another embodiment of the present general inventive concept.

Referring to FIG. 11, the wireless display source device 100 includes a controller 460 which sets a profile based on the user setting, and an encoder 150 which encodes the video data and the audio data according to the set profile.

The controller 460 includes a user setting storage unit 167 and the encoder setting unit 165.

The user setting storage unit 167 stores the user setting inputted from the user. The profile stored in the user setting may include, e.g., setting response time, setting quality or the like. Specifically, the profile stored in the user setting may include audio response time, audio quality, video response time, video quality or the like.

The encoder setting unit 165 sets a profile of the encoder 150 according to the user setting stored in the user setting storage unit 167. Here, as described above, the profile may include audio response time, audio quality, video response time, video quality or the like.

The encoder 150 includes the video encoder 151 which encodes and compresses the video data, and the audio encoder 152 which encodes and compresses the audio data.

Since the video encoder 151 and the audio encoder 152 are the same as the components described with reference to FIG. 4, a detailed description thereof will be omitted.

Hereinafter, there will be described an operation of the wireless display source device 100 during the wireless display according to a configuration in which a profile is set according to user setting in the wireless display source device 100 having the controller 460 of FIG. 11.

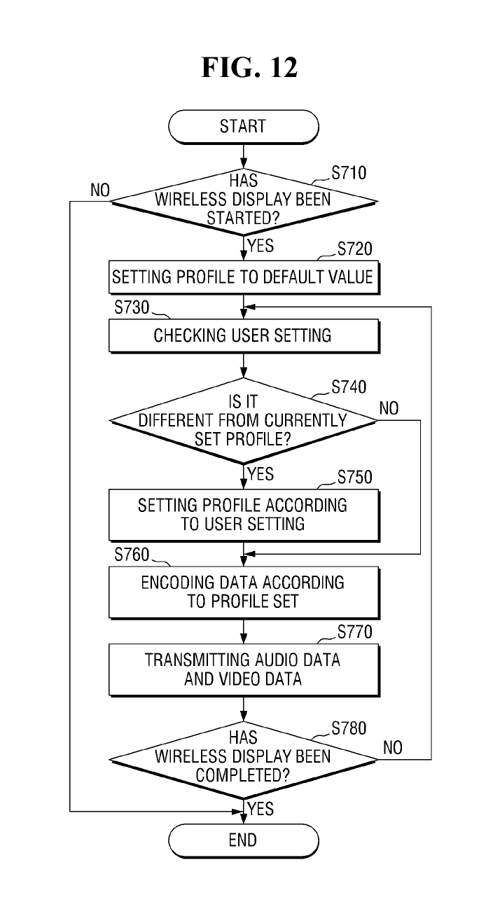

FIG. 12 is a schematic flowchart showing an operation of the wireless display source device 100 having a controller 460 as shown in FIG. 11, during the wireless display.

Referring to FIG. 12, first, the controller 460 determines whether the wireless display has been started (S710). Then, if the wireless display has been started, the controller 460 sets the profile of the encoder 150 to a default value (S720). Here, the default value represents an initial value to which the profile is set initially along with the start of the wireless display.

Next, the controller 460 checks the profile stored in the user setting (S730). Then, the controller 460 determines whether the currently set profile of the encoder 150 is different from the user setting (S740). If the currently set profile of the encoder 150 is different from the user setting, the controller 460 sets the profile of the encoder 150 according to the user setting (S750). If the currently set profile of the encoder 150 is the same as the user setting, setting the profile according to the user setting is omitted.

In the next step, the encoder 150 encodes the video data and the audio data according to the profile set by the controller 460 (S760). The encoded video data and the encoded audio data are multiplexed in the transport stream mux 170 according to, for example, the MPEG2-TS scheme, and packetized into the audio/video stream. The transport stream packet packetized into the audio/video stream is then capsulized into an IP packet in the transport stream processing unit 180.

Next, the wireless interface 190 transmits the audio data and the video data capsulized into the IP packet to the sink device 200 (S770). Finally, the controller 460 determines whether the wireless display has been completed (S780). If the wireless display has not been completed, the controller 460 repeats the above-described steps from S730.

In the wireless display source device 100 having the controller 460 of FIG. 11, since determining the frame update frequency and the compression ratio of the audio data and the video data according to the set profile is the same as that described above, a detailed description thereof will be omitted.

According to the above-described embodiments of the present general inventive concept, since the profile is set according to the type of the application, or the profile is set based on the system utilization information of the application, it is possible to dynamically set the profile of the encoder which exerts optimal performance according to the characteristics of the application. Accordingly, it is possible to reduce the response time and improve the image and sound quality of multimedia contents which are transmitted from the source device 100 and reproduced in the sink device 200 during the wireless display.

Further, according to the embodiment of the present general inventive concept, by setting the profile of the encoder requested by the user according to the user setting, it is possible to adjust the response time and the image and sound quality of multimedia contents, which are transmitted from the source device 100 and reproduced in the sink device 200 during the wireless display, according to the user's purpose.

In the above-described embodiments of the present general inventive concept, a case where the audio/video stream is transmitted from the source device 100 to the sink device 200 has been described, but the present general inventive concept is not limited thereto. That is, only the audio stream may be transmitted, only the video stream may be transmitted, or the audio stream and the video stream may be transmitted respectively.

According to the wireless display source device and sink device in accordance with the above-described embodiments of the present general inventive concept, since the wireless display source device encodes and transmits the multimedia contents according to various schemes, and the wireless display sink device receives the multimedia contents encoded according to various schemes, it is possible to achieve optimal quality and fast response time according to the characteristics of multimedia contents.

In concluding the detailed description, those skilled in the art will appreciate that many variations and modifications can be made to the preferred embodiments without substantially departing from the principles of the present general inventive concept. Therefore, the disclosed preferred embodiments of the general inventive concept are used in a generic and descriptive sense only and not for purposes of limitation.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A wireless display source device comprising:
an encoder which encodes a first multimedia signal according to a first scheme to generate a first encoded multimedia signal, and encodes a second multimedia signal different from the first multimedia signal according to a second scheme to generate a second encoded multimedia signal;
a controller which sets an encoding scheme of the encoder such that the first scheme is different from the second scheme; and
a wireless interface which transmits the encoded multimedia signals to a wireless display sink device.

2. The wireless display source device of claim 1, wherein the encoder receives the multimedia signals from an application, and
the controller determines a type of the application, and sets the respective encoding schemes of the encoder according to the determined type of the application.

3. The wireless display source device of claim 2, wherein the controller determines the type of the application based on state information of a communication module, a decoder, and a graphic engine used by the application.

4. The wireless display source device of claim 2, wherein the controller includes a preset selection unit which selects a preset determined in advance according to the type of the application, and an encoder setting unit which sets the encoding scheme according to the selected preset.

5. The wireless display source device of claim 4, wherein the preset determined in advance includes an audio codec corresponding to the type of the application.

6. The wireless display source device of claim 1, wherein the encoder receives the multimedia signals from an application, and
the controller sets the encoding scheme of the encoder based on system utilization information of the application.

7. The wireless display source device of claim 6, wherein the system utilization information of the application includes state information of a communication module, a decoder, and a graphic engine used by the application.

8. The wireless display source device of claim 6, wherein the controller includes a profile calculating unit which calculates a target profile based on the system utilization information of the application, and an encoder setting unit which sets the encoding scheme according to the calculated profile.

9. The wireless display source device of claim 1, wherein the encoder receives the multimedia signals from an application, and
the controller sets the encoding scheme of the encoder according to a user setting stored in advance.

10. A wireless display source device comprising:
an encoder which receives and encodes a multimedia signal to generate an encoded multimedia signal;
a controller which changes an encoding scheme of the multimedia signal by setting encoding parameters of the encoder according to system utilization information; and
a wireless interface which transmits the encoded multimedia signal to a wireless display sink device.

11. The wireless display source device of claim 10, wherein the encoder receives the multimedia signal from an application, and
the system utilization information includes state information of a communication module, a decoder, and a graphic engine used by the application.

12. The wireless display source device of claim 10, wherein the encoding parameters include response time and quality.

13. The wireless display source device of claim 12, wherein the controller includes a preset selection unit which selects a preset determined in advance according to a type of the application, and an encoder setting unit which sets the response time or the quality according to the selected preset.

14. The wireless display source device of claim 12, wherein the encoder determines a compression ratio for encoding the multimedia signal according to at least one of the response time and the quality.

15. The wireless display source device of claim 12, wherein the encoder determines a frame size of the encoded multimedia signal according to at least one of the response time and the quality.

16. A wireless display source device, comprising:
an encoder to receive and encode a multimedia signal;
a controller to select an encoding scheme for the encoder from a plurality of stored encoding profiles; and
a wireless interface which transmits the encoded multimedia signal to a wireless display sink device;
wherein the plurality of stored encoding profiles vary in terms of audio and video encoding formats associated with respective profiles.

17. The wireless display source device of claim 16, further comprising a display panel to display video data related to the multimedia signal.

18. The wireless display source device of claim 16, further comprising a speaker to produce audio data related to the multimedia signal.

19. The wireless display source device of claim 16,
wherein the encoder is connected to receive the multimedia signal from an application; and
wherein the controller is configured to dynamically select an encoding profile for the application having video and audio settings optimal for the application.

20. The wireless display source device of claim 19, wherein the controller is configured to select the optimal encoding profile based on an evaluation of audio response time, audio quality, video response time, and video quality.
